(19) United States
(12) Patent Application Publication
(10) Pub. No.: US 2025/0248433 A1
(43) Pub. Date: Aug. 7, 2025

(54) SINGLE-BATCH AND MULTI-BATCH CONVERTIBLE ROASTING APPARATUS AND METHODS

(71) Applicant: Bellwether Coffee Co., Berkeley, CA (US)

(72) Inventors: Peter RIVE, Lisboa (PT); Jasvir SANDHU, Boulder, CO (US); Ricardo LOPEZ, Bolinas, CA (US); Peter SCHMEHL, Berkeley, CA (US); Stewart SCHMEHL, Pinehurst, NC (US); William WRIGHT, Berkeley, CA (US); Parinya N. LEELHASUWAN, Pinole, CA (US); William Henry FRENCH, III, Petaluma, CA (US)

(21) Appl. No.: 19/046,257

(22) Filed: Feb. 5, 2025

Related U.S. Application Data
(60) Provisional application No. 63/549,815, filed on Feb. 5, 2024.

(51) Int. Cl. A23N 12/12; A23F 5/04; A23N 12/10

(52) U.S. Cl. CPC A23N 12/125; A23F 5/04; A23N 12/10

(57) ABSTRACT

An apparatus according to an embodiment includes a bean roaster core, an autoloader configured to be removably coupled to the bean roaster core, and a bulk receiver configured to be removably coupled to the bean roaster core. The bean roaster core includes a roasting drum and a recirculating air subsystem fluidically coupled to the roasting drum, and has a single-batch configuration and a multi-batch configuration. The bean roaster core is in the multi-batch configuration when the autoloader is removably coupled to the bean roaster core. The autoloader is not removably coupled to the bean roaster core when the bean roaster core is in the single-batch configuration. The bulk receiver is configured to receive a product or a byproduct of a roasting process from the bean roaster core when the bean roaster core is in the multi-batch configuration and the bulk receiver is removably coupled to the bean roaster core.

### CROSS-REFERENCE TO RELATED APPLICATION

This application claims priority to and the benefit of U.S. Patent Application No. 63/549,815, filed on Feb. 5, 2024 and titled “Apparatus and Methods for Roasting Multiple Batches of Food Products Continuously,” which is incorporated by reference herein.

### TECHNICAL FIELD

The disclosure relates generally to roasters that can continuously or consecutively roast multiple batches of food products such as beans, and more particularly to coffee beans, including to roasters that can covert between roasting discrete, single batches and continuous or consecutive multiple batches.

### BACKGROUND

Food roasting machines are known including, for example, roasting machines used to prepare coffee beans either to be ground and brewed or to be packaged. Such known bean roasting machines typically are configured only for one type of use, either for the beans to be ground and brewed or to be packaged. Thus, a need exists for a bean roasting system can be converted between the two types of use.

### SUMMARY

An apparatus according to an embodiment includes a bean roaster core, an autoloader configured to be removably coupled to the bean roaster core, and a bulk receiver configured to be removably coupled to the bean roaster core. The bean roaster core includes a roasting drum and a recirculating air subsystem fluidically coupled to the roasting drum, and has a single-batch configuration and a multi-batch configuration. The bean roaster core is in the multi-batch configuration when the autoloader is removably coupled to the bean roaster core. The autoloader is not removably coupled to the bean roaster core when the bean roaster core is in the single-batch configuration. The bulk receiver is configured to receive a product or a byproduct of a roasting process from the bean roaster core when the bean roaster core is in the multi-batch configuration and the bulk receiver is removably coupled to the bean roaster core.

### BRIEF DESCRIPTION OF THE DRAWINGS

FIG. 1 is a schematic illustration of an apparatus according to an embodiment.

FIG. 2 is a schematic illustration of a recirculating air system of the apparatus of FIG. 1.

FIG. 3 is a front view of an apparatus in a single-batch (e.g., countertop) configuration (at right in FIG. 3) and a multi-batch (e.g., an accessorized, continuous roasting) configuration (at left in FIG. 3), according to an embodiment.

FIG. 4 is a perspective view of an autoloader subsystem of the apparatus of FIG. 3.

FIG. 5 is a perspective view of a portion of the autoloader subsystem of FIG. 4, which a portion of a housing removed for illustration purposes.

FIGS. 6 and 7 are perspective views of interior portions of a bulk receiver of the apparatus of FIG. 3.

FIGS. 8-10 show various screen shots from a user interface for a bean roaster in a multi-batch (e.g., accessorized, continuous roasting) configuration, according to an embodiment.

FIGS. 11-12 show various screen shots from a user interface for a bean roaster in a single-batch (e.g., countertop) configuration, according to an embodiment.

FIGS. 13-18 show various views of the apparatus of FIG. 3 in various states of conversion from a single-batch configuration to a multi-batch configuration, according to an embodiment.

### DETAILED DESCRIPTION

In one or more embodiments, a bean roaster can be transformed from a single use coffee roaster (e.g., for independent cafes) to one that roasts continuously (e.g., for users/operators that desire larger volumes to be roasted for retail bag customers or wholesale distribution of roasted coffee). To convert the bean roaster from a single-use configuration (also referred to herein as a “single use countertop configuration” or “single-batch configuration”) to a continuous-use configuration (also referred to as a “multi-use configuration” or “multi-batch configuration”), an autoloader and a bulk receiver are added as described below.

In one or more embodiments, the bean roaster in the multi-use configuration can be considered to roast continuously in the sense that the user (operator) can load into the bean roaster a large amount (e.g., by weight, volume, number, or the like) of beans that exceeds an amount that can be roasted in the single batch and then have the bean roaster roast the beans in multiple consecutive batches without further intervention from the user (operator). In some implementations, consecutive batches of beans can be roasted with a small amount of time between adjacent batches (e.g., 1 minute, 2 minutes, 3 minutes, or 4 minutes, etc. between adjacent batches). In some implementations, consecutive batches of beans can be roasted with little to no time between adjacent batches. In yet other embodiments, consecutive batches of beans can be roasted with an overlap between adjacent batches, for example, where a first batch has been roasted and is being cooled in a cooling tray while a second batch is being roasted.

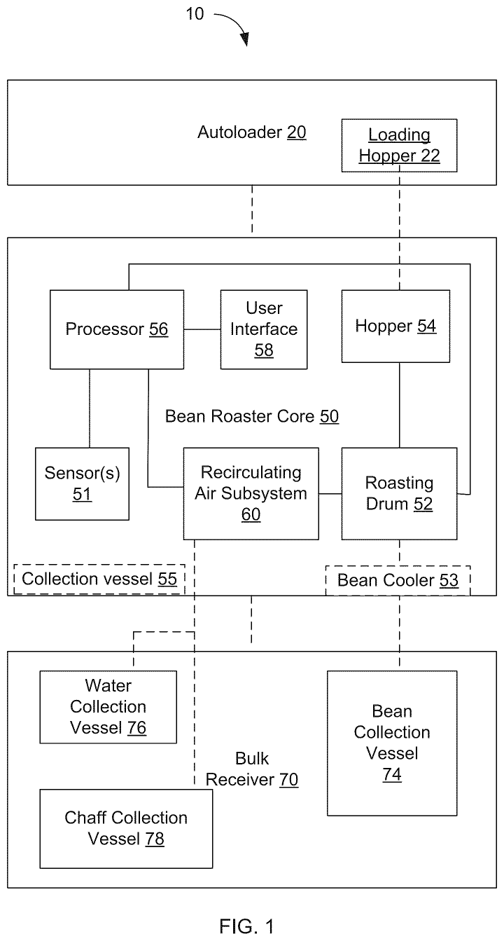

FIG. 1 is a schematic illustration of an apparatus 10 according to an embodiment. The apparatus 10 can be a bean roaster configured for roasting beans (e.g., coffee beans). The apparatus 10 includes a bean roaster core 50. The apparatus 10 also includes an autoloader 20 and a bulk receiver 70, each removably coupleable to the bean roaster core 50. The apparatus 10, and more particularly, the bean roaster core 50, has a single-batch configuration, in which the bean roaster core 50 is not coupled to the autoloader 20 and/or the bulk receiver 70, and a multi-batch configuration, in which the bean roaster core 50 is coupled to the autoloader 20 and/or the bulk receiver 70.

The autoloader 20 includes a loading hopper 22 that is configured to receive an amount of beans and to selectively dispense a predetermined amount of the beans, which predetermined amount is less than the amount received in the loading hopper, to the bean roaster core 50. The beans can be dispensed from the autoloader 20 to a hopper 54 of the bean roaster core, which can dispense the beans to a roasting drum 52 within which the beans can be roasted based on roasting instructions received from a processor 56 of the bean roaster core 50. The bean roaster core 50 can include a bean cooler 53, which receives the beans from the roasting drum 52 when the bean roaster core 50 is in the single-batch configuration and which can be removed for insertion of an adapter (not shown in FIG. 1) with an integral bean cooler that dispenses roasted (and cooled) beans to a bean collection vessel 74 of the bulk receiver 70. The bean roaster core 50 can include a user interface 58 that is configured to present a first set of screens or displays (e.g., screenshots) to a user when the bulk roaster core 50 is in the single-batch configuration and a second set of screens or displays (e.g., screenshots) to a user when the bulk roaster core 50 is in the multi-batch configuration. The second set of screens can include one or more screens that correspond to one or more screens available in the single-batch configuration as well as one or more additional screens that are not available to the user in the single-batch configuration.

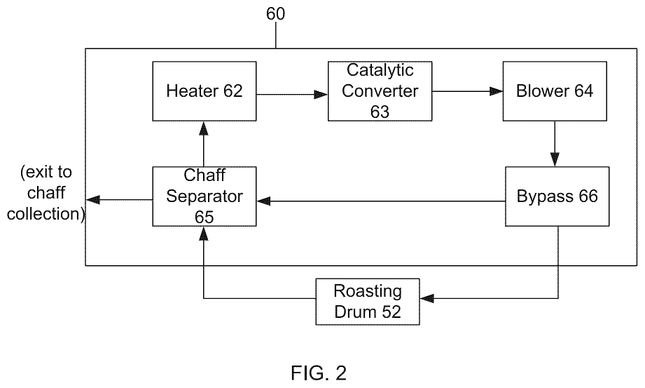

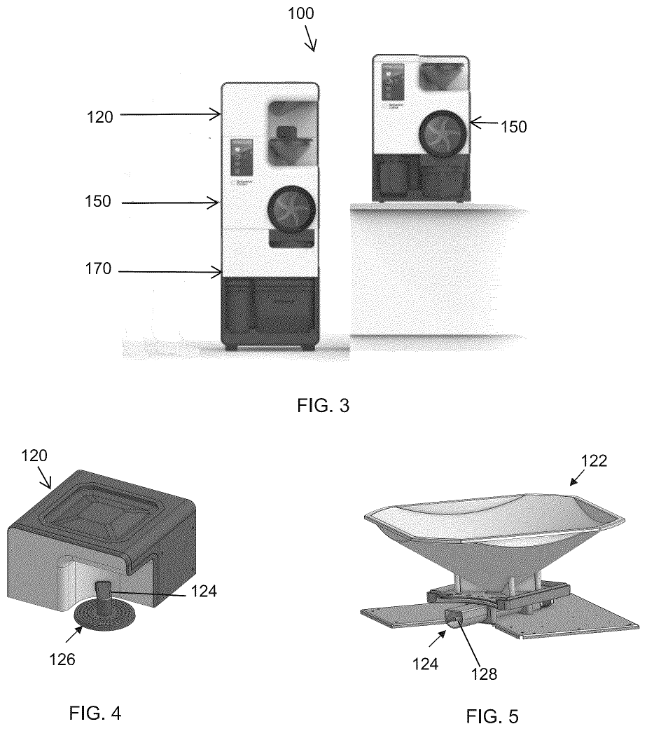

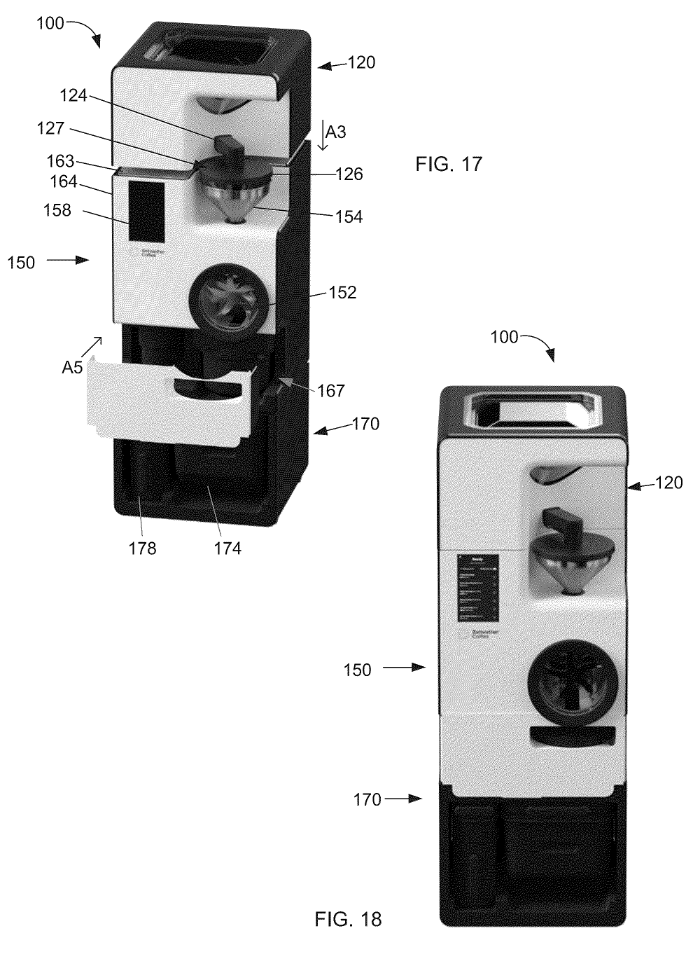

The bulk roaster core 50 can include one or more sensors 51 configured to detect when the autoloader 20 is coupled to the bean roaster core 50 and/or when the bulk receiver 70 is coupled to the bean roaster core 50. The bean roaster core 50 includes a recirculating air subsystem 60 that is fluidically coupled to the roasting drum 52 and that can be selectively fluidically isolated (e.g., based on a signal from the processor 56) from the roasting drum 52, such as via a drum bypass valve 66 (see, e.g., FIG. 2). As described in more detail herein with respect to apparatus 100 (shown in FIGS. 3-7 and 13-18), the recirculating air subsystem 60 is configured to maintain a flow of heated air therein, which helps to reduce time between roasting batches of beans. The recirculating air subsystem 60 can include a heater 62, a catalyst (or catalytic converter) 63, a blower 64, the roasting drum 52, a chaff separator 65, and a bypass valve 66 as described herein.

The bean core roaster 50 can include a removable collection vessel 55 that is configured to collect waste byproduct (e.g., chaff and/or water) from the roasting operation. The collection vessel 55 can be received in the bean core roaster 50 in the single-batch configuration, and can be removed from the bean core roaster 50 in the multi-batch configuration. In the multi-batch configuration, the bean core roaster 50 can receive an adapter configured to couple to a water collection vessel 76 and a chaff collection vessel 78 of the bulk receiver 70. The various components of apparatus 10 can be the same as or similar in many respects to similar components of any apparatus described herein, including, for example, apparatus 100.

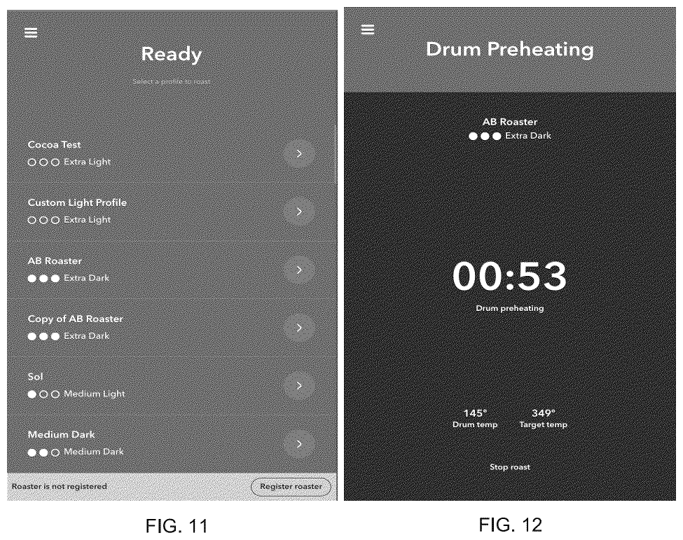

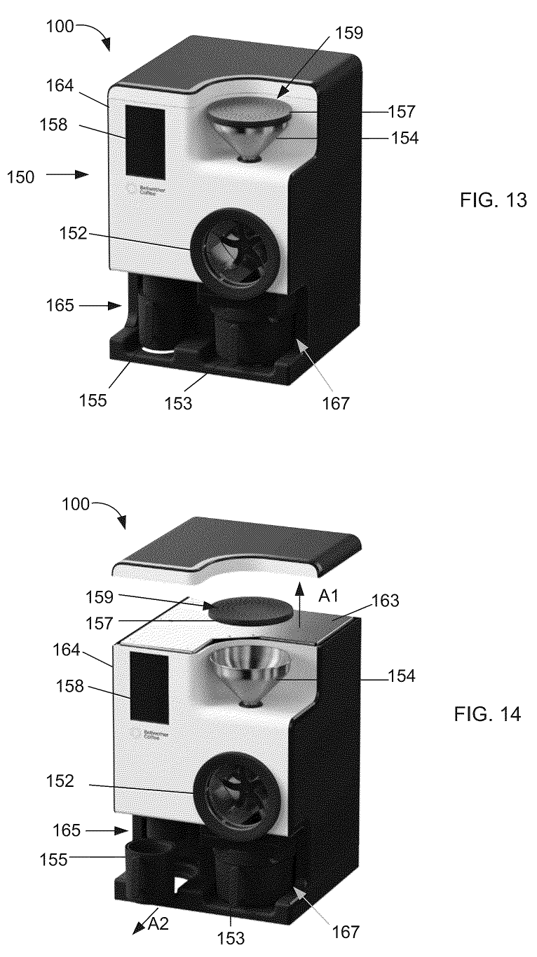

FIG. 3 shows a front view of an apparatus 100 (e.g., a bean roaster) in a single use countertop configuration and an accessorized, continuous roasting configuration, according to an embodiment. More specifically, the bean roaster in the single use countertop configuration (also referred to herein as the “single-use configuration” or “single batch configuration”) is shown on the right side of FIG. 3, and the accessorized, continuous roasting configuration (also referred to herein as the “multi-use configuration” or “multi-batch configuration”) is shown in the left/middle of FIG. 3. FIGS. 13-18 show the apparatus 100 in various stages of conversion from the single-batch configuration (see, e.g., FIG. 11) to the multi-batch configuration (see, e.g., FIG. 16). The apparatus 100 can also be converted from the multi-batch configuration to (or back to) the single-batch configuration, for example, by a reverse process. The apparatus 100 and/or components thereof can be identical or similar in many respects to apparatus 10 and/or components thereof.

The bean roaster core 150 includes a roasting drum 152 and a recirculating air subsystem 160 fluidically coupled to the roasting drum 152. The roasting drum 152 and recirculating air subsystem 160 can be disposed in a housing 164 of the bean roaster core 150. The bean roaster core 150 can include a hopper 154 that is configured to receive beans. The hopper 154 is coupled to the roasting drum 152, such that beans received in the hopper 154 can be released to the roasting drum 152. In some implementations, the hopper 154 is sized to receive no more than a single batch of beans (as described herein). The bean roaster core 150 in the single-batch configuration includes a lid 157 removably coupled to the hopper 154. The lid 157 is not coupled to the hopper 154 when the bean roaster core 150 is in the multi-batch configuration. Rather, the lid is effectively replaced by a vented lid 126 of the autoloader 120, as described herein, as the vented lid 126 is removably disposed on the hopper 154 of the bean roaster core 150 when the bean roaster core 150 is in the multi-batch configuration.

The bean roaster core 150 defines a recess 165; for example, the recess 165 can be defined by the housing 164 of the bean roaster core 150. The bean roaster core 150 receives in the recess 165 a removable chaff and water collection vessel 155, when the bean roaster core 150 is in the single-batch configuration. The bean roaster core 150 receives in the recess 165 at least a portion of an adapter 180, described in more detail herein, to couple to a removable chaff collection vessel 178 of the bulk receiver 170 and to a removable water collection vessel 175 of the bulk receiver 170 when the bean roaster core 150 is in the multi-batch configuration. Although the removable chaff collection vessel 178 and the removable water collection vessel 175 of the bulk receiver 170 are shown as being distinct vessels, in some implementations, the removable chaff collection vessel 178 and the removable water collection vessel 175 can be formed as a unity vessel, for example, with separate collection chambers for water and chaff collection.

The bean roaster core 150 can also include a recess 167 configured to receive a removable bean cooler. The bean roaster core 150 includes the removable bean cooler 153 when the bean roaster core 150 is in the single-batch configuration. In the single-batch configuration, the removable bean cooler 153 receives beans from the roasting drum 152 after roasting and cools the beans therein. The bean roaster core 150 in the multi-batch configuration includes an adapter 184 including a bean cooler, described in more detail herein.

The recess 165 of the bean roaster core 150 that receives the removable chaff and water collection vessel and the recess 167 of the bean roaster core 150 that receives the removable bean cooler 153 can be distinct from each other, can be contiguous, or can collectively define a single recess.

As briefly discussed above, the bean roaster core 150 has the single-batch configuration and a multi-batch configuration. More specifically, as shown in FIG. 1, the bean roaster in the single use countertop (or single-batch) configuration (also referred to herein as the “bean roaster core”) can be converted (transformed) to the accessorized, continuous roasting (or multi-batch) configuration by adding an autoloader 120 to the top of the bean roaster core 150 and/or the bulk receiver 170 at the bottom of the bean roaster core 150. Said differently, the bean roaster core 150 is in the multi-batch configuration when the autoloader 120 is removably coupled to the bean roaster core 150. The bean roaster core 150 is in the single-batch configuration when the autoloader 120 is not removably coupled to the bean roaster core 150. In other words, the autoloader 120 is not removably coupled to the bean roaster core 150 when the bean roaster core 150 is in the single-batch configuration. In some implementations, the bean roaster core 150 is in the multi-batch configuration when both the autoloader 120 and the bulk receiver 170 are each removably coupled to the bean roaster core 150, and the bean roaster core 150 is in the single-batch configuration when the autoloader 120 and the bulk receiver 170 are both not removably coupled to the bean roaster core 150.

FIGS. 4 and 5 show an autoloader 120 (also referred to as an autoloader subsystem), according to an embodiment. More specifically, FIG. 4 shows a perspective view of an exterior of the autoloader. FIG. 5 shows a perspective view of an interior portion of the autoloader without the housing. The autoloader 120 is configured to be removably coupled to the bean roaster core 150. The bean roaster core 150 is in the multi-batch configuration when the autoloader 120 is removably coupled to the bean roaster core 150. The autoloader 120 is not removably coupled to the bean roaster core 150 when the bean roaster core 150 is in the single-batch configuration. The autoloader 120 is a subsystem that can be disposed on a top surface 163 of the bean roaster core 150 (or, more specifically, a top surface 163 of the housing 164 of the bean roaster core 150) (e.g., by lowering the autoloader 120 onto the top surface 163 of the housing 164 of the bean roaster core 150 in the direction of arrow A3, shown in FIG. 16). In some implementations, as shown in FIG. 14, a top wall or lid of the housing 164 of the bean roaster core 150 is removed (e.g., in the direction of arrow A1 shown in FIG. 14) to expose the top surface 163 that receives the autoloader 120. The autoloader 120 can be coupled to the bean roaster core 150 (or the top surface 163 thereof) in any suitable manner, including mating connectors, a resistance fit, magnetic connectors, latch(es), mating recess(es) and/or protrusion(s). In some implementations, the weight of the autoloader 120 is sufficient to resist movement of the autoloader 120 with respect to the bean roaster core 150, without an additional coupling mechanism. In some implementations, an electrical connection is produced or completed between the autoloader 120 and the bean roaster core 150, when the autoloader 120 is disposed on the top surface 163 of the bean roaster core 150.

Referring again to FIGS. 4-5, the autoloader 120 can include a housing, a nozzle 124 extended from the housing (e.g., in a recess defined by the autoloader housing), and a vented lid 126 coupled to the nozzle 124. Referring to FIG. 5, the autoloader 120 can include a loading hopper 122 (also referred to herein as a “bean roaster hopper” or “hopper”), which can be received in the housing of the autoloader 120. The autoloader 120 is configured to receive a volume of beans. For example, the loading hopper 122 is sized to hold or otherwise receive the large volume of beans (e.g., up to about 13 roasts equivalent of green coffee beans, which can be about 40 to about 45 pounds (about 18 Kg to about 20 Kg), or more specifically about 43 pounds (about 19.5 Kg) of green coffee beans. Although the apparatus is described herein as roasting green beans (such as green coffee beans), the apparatus can also be used for roasting partially-roasted beans.

The autoloader 120 is configured to release a first predetermined portion of the beans to the bean roaster core 150 during (or at) a first time of a multi-batch roasting operation when the bean roaster core 150 is in the multi-batch configuration and performing the multi-batch roasting operation. The autoloader 120 is configured to release a second predetermined portion of the beans to the bean roaster core 150 during (or at) a second time of the multi-batch roasting operation when the bean roaster core 150 is in the multi-batch configuration and performing the multi-batch roasting operation. Said another way, the loaded can be selectively or controllably dispensed in increments, for example in increments of 3.3 pounds (1.5 Kg), from the loading hopper 122 to the bean roaster core 150. The release of the second predetermined portion of the beans can be in response to a signal from a processor (e.g., identical or similar to processor 56 of apparatus 10) of the bean roaster core 150, and more particularly in response to a signal from the processor that is sent automatically and without user intervention after initiation of the multi-batch roasting operation. The processor can be configured to send the signal based on roasting parameters selected prior to initiation of the multi-batch roasting operation. The recirculating air subsystem 160 of the bean roaster core 150 can be configured to continuously recirculate heated air within the recirculating air subsystem 160 during the multi-batch roasting operation and including at a third time between the first time and the second time. The recirculating air subsystem 160 of the bean roaster core 150 can also be configured to continuously recirculate heated air within the recirculating air subsystem 160 during the multi-batch roasting operation and including the first time, the third time between the first time and the second time, and the second time.

The nozzle 124 of the autoloader 120 is coupled to the loading hopper 122. The nozzle 124 defines a pathway for movement of the beans in a direction (e.g., a first direction) (away) from the loading hopper 122. The direction can be along an axis that is transverse to a central (or vertical) axis of the loading hopper 122. The direction can lead laterally away from the loading hopper 122. The nozzle 124 defines an exit of the pathway through which the beans can move from the nozzle 124 and towards the bean roaster core 150. The nozzle 124 exit can be positioned such that the beans exit the pathway in a second direction different than the first direction. For example, the beans can exit the pathway in a direction that is transverse to, or optionally substantially perpendicular to, the direction of movement of the beans within the pathway of the nozzle 124. The nozzle 124 exit can be positioned to release the batch of beans to the bean roaster core 150 (e.g., to a hopper 154 of the bean roaster core 150). The nozzle 124 exit can be positioned above the hopper 154 of the bean roaster core 150, thereby allowing gravity to facilitate release of the beans from the nozzle 124 exit to the hopper 154 of the bean roaster core 150.

The autoloader 120 can include an auger 128 at least partially disposed within the nozzle 124. This can be referred to, for example, as an integrated auger and dispensing nozzle 124. The auger 128 is configured to rotate within the pathway of the nozzle 124 to facilitate movement of the beans, for example in the direction (e.g., the first direction, or away from the loading hopper 122), through the pathway. Because the auger 128 can move or advance the beans within the pathway, the pathway defined by the nozzle 124 can optionally be substantially horizontal, such that the nozzle 124 does not rely on gravity to move the beans within the pathway. In some embodiments, the auger 128 is configured to selectively reverse the direction of rotation, for example, to help clear the nozzle 124 by removing any beans or portions thereof that may have become stuck within the nozzle 124 pathway. The autoloader 120 also connects to the bean roaster core 150 by way of an electrical connection through which power and control signals can be transmitted from the bean roaster core 150 (or the processor thereof) to activate and/or modulate the autoloader 120. In some embodiments, the auger 128 can be controlled via a stepper-motor or other suitable drive mechanism. The bean roaster core 150 can also include an integrated scale (not shown) configured to measure the amount of beans that is being (or has been) dispensed, to ensure each batch or load of beans is accurately dispensed. In this manner, the autoloader 120 can be configured to automatically stop dispensing beans when a predetermined amount of beans has been dispensed. For example, the auger 128 can be stopped, to stop advancement of the beans within the nozzle 124. In another example, a door at an exit of the loading hopper 122 to the nozzle 124 can be engaged to close the exit of the loading hopper 122 to the nozzle 124.

As shown in FIGS. 4 and 16, the autoloader 120 includes a vented lid 126 coupled to the nozzle 124. The vented lid 126 is configured to be removably disposed on the hopper 154 of the bean roaster core 150 when the bean roaster core 150 is in the multi-batch configuration. The vented lid 126 defines multiple vent holes 127 (or apertures) positioned around a lumen connected to the nozzle 124 (or more specifically, the lumen of the vented lid 126 is fluidically coupled to the pathway of the nozzle 124, such that beans can pass through the lumen of the vented lid 126 when the beans exit the pathway via the nozzle 124 exit). The vented lid 126, when coupled to or otherwise removably disposed on the hopper 154 of the bean roaster core 150, is configured to permit heat from the bean roaster core 150 to vent to the exterior of the bean roaster core 150, e.g., during a roasting operation.

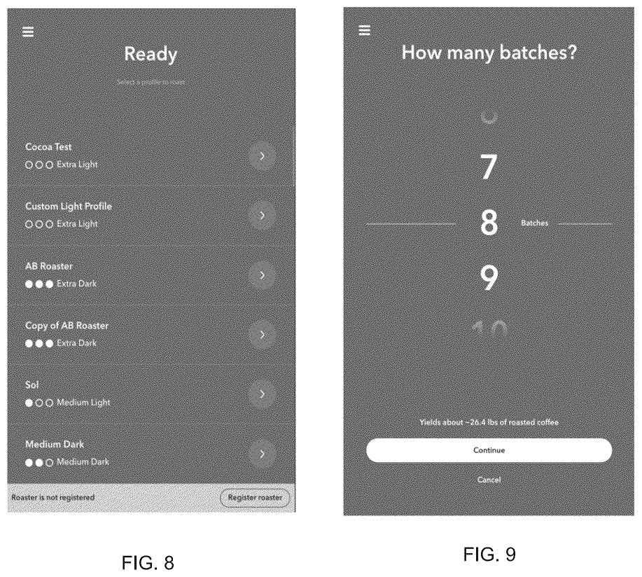

In use, the processor of the bean roaster core 150 can receive a signal indicating attachment of the autoloader 120 and presents a different set of screens and/or prompts via a user interface 158 (e.g., from the screen shots in FIGS. 11-12 to the screen shots in FIGS. 8-10, which are discussed further below), for example, to allow the user to select how many batches are to be automatically dispensed into the bean roaster. Upon selection of the number of batches by the user via the user interface 158, the bean roaster in the multi-batch roasting configuration can be left unattended while the bean roaster automatically and continuously (as described herein) roasts the selected number of batches. This greatly reduces the amount of labor used to roast coffee, hence allowing operators of the bean roaster to roast more coffee, with less effort.

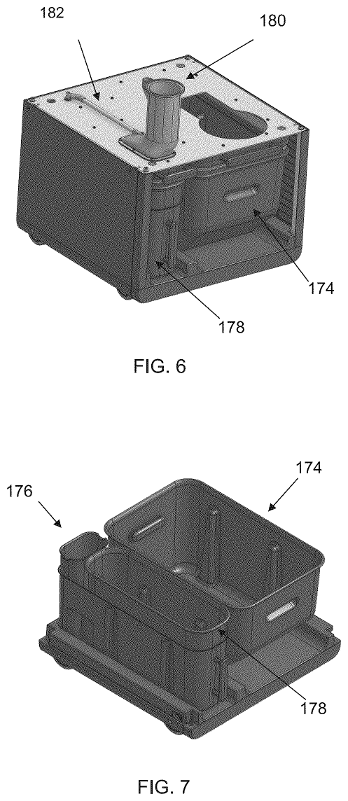

FIGS. 6 and 7 show portions of the bulk receiver 170 (BR), according to an embodiment. The bulk receiver 170 is configured to be removably coupled to the bean roaster core 150. The bulk receiver 170 is configured to receive a product and/or a byproduct of a roasting process from the bean roaster core 150 when the bean roaster core 150 is in the multi-batch configuration and the bulk receiver 170 is removably coupled to the bean roaster core 150. As shown in FIGS. 6 and 7, the bulk receiver 170 includes a bean collection vessel (or container) 174, a chaff collection vessel 178 (or chaff container), a water collection vessel 175 (or water container), an adapter 180 (e.g., that is or includes a chaff conduit) and water conduit 182. The bean collection vessel 174 is large enough to hold multiple batches of beans after being roasted and cooled in individual, consecutive batches. The bean collection vessel 174 is removably disposed within the bulk receiver 170 so that the bean collection vessel 174 can be removed to empty roasted beans and reinserted to receive and contain future batches of roasted beans. The chaff collection vessel 178 and the water collection vessel 175 are each large enough to hold the chaff and water, respectively, produced during the multiple batches of roasted beans during continuous/consecutive roasting. The chaff collection vessel 178 and the water collection vessel 175 can be removably disposed within the bulk receiver 170 so that they can be removed to be emptied and reinserted to contain the residual chaff and residual water produced during future continuous/consecutive roasting.

The bulk receiver 170 doubles as a stand for the bean roaster and has casters (rollers) to allow for the bean roaster with bulk receiver 170 (and autoloader 120) to be moved within a space (e.g., within a café). The bulk receiver 170 has a structural component (e.g., box-like walls) to support the weight of the bean roaster as well as the autoloader 120, which is typically installed on top of the bean roaster core 150. The three components of this three-component system interlock/complimentarily fit so as to appear to be one integrated machine.

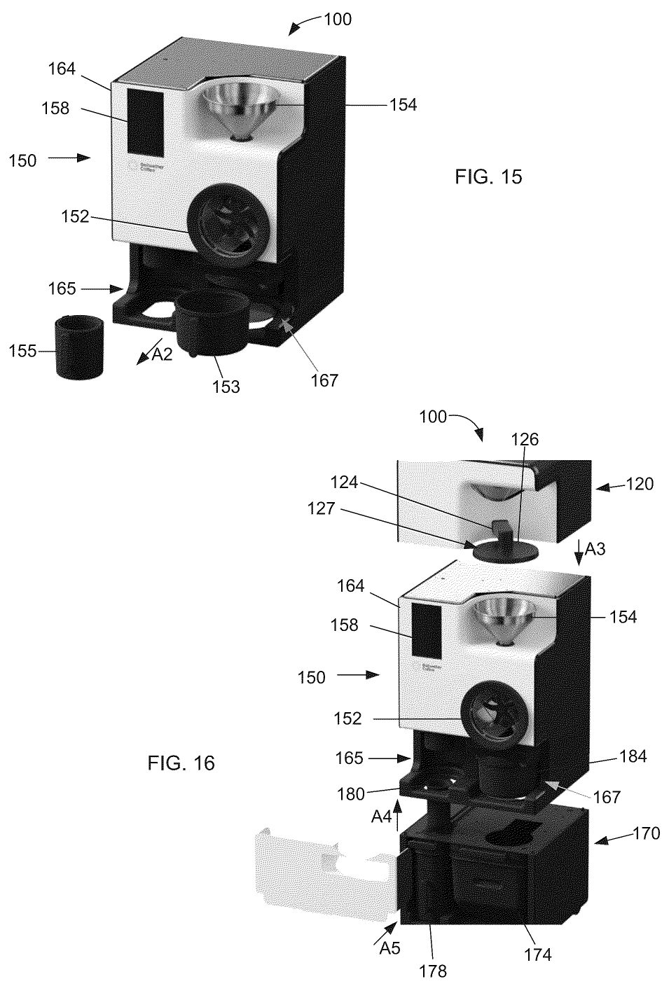

As briefly discussed above, the bulk receiver 170 can have at least two functions. First, the bulk receiver 170 can hold multiple batches of roasted beans (e.g., hold up to 13 batches of roasted coffee beans, or otherwise hold up to an amount of beans substantially similar to the amount configured to be received by the loading hopper 122). Second, the bulk receiver 170 can hold the waste byproducts of multiple batches of roasting (e.g., 13 batches of roasting) to accommodate the waste byproducts produced during the roasting process. For example, the waste byproducts can include, for example, wastewater and chaff. When the bean roaster core 150 is in the single-batch configuration, the bean roaster core 150 includes a chaff and water collection vessel 155 (also referred to as an integrated chaff and water can) that is removable from the bean roaster core 150. For example, when the bean roaster core 150 is in the single-batch configuration, the chaff and water collection vessel 155 can be received in a recess 165 of the housing 164 of the bean roaster core 150. When the bean roaster core 150 is in the multi-batch configuration, however, the chaff and water collection vessel 155 is not received in the recess 165 of the housing 164 of the bean roaster core 150. For example, the chaff and water collection vessel 155 can be removed from the recess 165 of the housing 164 in the direction of arrow A2 shown in FIG. 15. Rather, when the bean roaster core 150 is integrated on top of or otherwise coupled to the bulk receiver 170 in the multi-batch configuration, the chaff collection path can be hermetically sealed to the chaff separator of the bean roaster core 150. This sealing can be achieved by a sealing mechanism (e.g., a gasket made from rubber, silicone, nitrile, vinyl and/or neoprene) to be used to connect these components.

The process of connecting the bulk receiver 170 to the bean roaster core 150 can include removing both the chaff and water collection vessel 155 (also referred to as a chaff collection bucket) and the bean cooler 153 from the bean roaster core 150 (e.g., by moving each in the direction of arrow A2 shown in FIG. 15) and replacing these with adapters 180, 184 that provide for flow of the waste byproducts and roasting products, respectively, from the bean roaster core 150 to the collection vessel(s) of the bulk receiver 170. The adapter 180 can be received in the recess 165 in the direction of arrow A4 shown in FIG. 16, for example, by disposing the bean roaster core 150 onto an upper surface of the bulk receiver 170. The adapter 184 can be received in the recess 167 by insertion of the adapter into the recess 167 in the direction of arrow A5 shown in FIG. 16. As also shown in FIGS. 16-18, a panel can be installed onto the bean roaster core 150 in the multi-batch configuration such that the panel is at least partially disposed over (or in front of) the recesses 165, 167 and/or adapters 180, 184.

In the case of the waste byproducts, the adapter 180 (also referred to herein as a second adapter) can be or include a chaff conduit, such as a silicon rubber boot, which can be sealed on one end to a cyclonic chaff collection system (e.g., a cyclonic separator) of the bean roaster core 150 and on the other end to the bulk receiver 170's expanded chaff collection vessel. A sealing mechanism (e.g., with an actuator or motor) can raise and lower a sealing plate (e.g., having a gasket made from rubber, silicone, nitrile, vinyl and/or neoprene) to allow for collection of chaff and ease of removal of the waste container. The expanded water collection vessel 175 and chaff collection vessel 178 are located on a tray, which is movable (e.g., slidable) into and out from the bean roaster in the accessorized, continuous (multi-batch) roasting configuration, for ease of access. The water path includes a water conduit 182 (e.g., an extension pipe) that directs waste water into the expanded water collector in the bulk receiver 170, which can be positioned behind the chaff collection vessel 178.

With respect to the roasted beans, the roasted bean adapter 184 (or first adapter) replaces the removable bean cooler 153 with a bean cooler (also referred to herein as an integral bean cooler or a fixed in-place bean cooler) that is configured to receive the beans after roasting and from the roasting drum 152. The bean cooler of the adapter 184 is configured to cool the beans therein. The bean cooler of the adapter 184 has a first configuration in which the bean cooler is open to the bean collection vessel 174 of the bulk receiver 170 and a second configuration in which the bean cooler is closed to the removable bean collection vessel 174 of the bulk receiver 170. For example, the bean cooler of the bulk receiver 170 can include a rotating flap (not shown) at its bottom. The bean collection vessel 174 can define an opening with a cut-out portion, as shown in FIG. 16, that is shaped to permit the flap to rotate therethrough. The rotation of the flap allows the expulsion of cooled beans into the bean collection vessel 174 (also referred to as an expanded bean collector). The bulk receiver 170 can include one or more sensors that detect whether the roasted bean bucket is in place to ensure that beans are not dispensed onto the floor, hence preventing the loss of roasted product. Like the autoloader 120, the bean roaster core 150 can detect the presence of the bulk receiver 170 to ensure that all control actions match the setup of the bean roaster core 150 in the accessorized, continuous roasting configuration.

To perform continuous roasting within a close space (e.g., within a café), certain challenges are overcome by the one or more embodiments of a bean roaster described herein. For example, recirculating and scrubbing air within a bean roaster performing continuous roasting is desirable. Details about an example of a recirculating and scrubbing subsystem for a roasting system are described in U.S. Pat. No. 11,641,870 entitled “Roasting System with Clean Emissions and High Thermal Efficiency”, the contents of which are incorporated herein by reference.

Without recirculation, the amount of energy used to roast can be impermissibly excessive and can lead one to consider alternative systems, for example, with natural gas heating and with external venting. In most cases, with higher capacity systems, an incinerator or after-burner is also mandated by municipalities and federal regulation. In one implementation, such recirculating air can be achieved by a bean roaster having a hot recirculating path, or recirculating air subsystem 160, that includes a heater (see, e.g., heater 62 of apparatus 100), a catalyst (or catalytic converter) (see, e.g., catalytic converter 63 of apparatus 100), a blower (see, e.g., blower 64 of apparatus 100), the roasting drum 152, a chaff separator (see, e.g., chaff separator 65 of apparatus 100), and a bypass valve (see, e.g., bypass valve 66 of apparatus 100) as described herein.

The performance of roasting systems that are closed and sealed to the outside can be undesirably hampered by the buildup of moisture from the roasting process, and the reduction in oxygen available for air scrubbing via the catalyst. Hence, it is desirable for recirculating roasting systems that support continuous roasting, like the apparatus including the bean roaster core 150 described herein, to have a fresh air exchange system that can exhaust a portion of the roasting air from the recirculating air subsystem 160 (e.g., the hot path) via a condenser and exhaust filtration system (see, e.g., the vented lid 126 of FIG. 4). This exhausted air can be replaced by fresh air that enters through the vented lid 126 of FIG. 4.

One interesting facet of continuous roasting is that at the end of a roast, an inner surface of the roasting drum 152 may have reached temperatures close to the final roast temperature. For light roasts, this may be between 400° F.-415° F. For dark roasts, this may be over 450° F. That high of a drum temperature, however, is non-ideal for starting the next roast and can lead to roasting defects on the green beans that enter the roasting drum 152 at the start of roast. To improve roasting quality and reduce the time between batches in continuous roasting, a drum bypass can be included within the bean roaster. More specifically, the recirculating air subsystem 160 of the bean roaster core 150 can be configured to continuously recirculate heated air within the recirculating air subsystem 160 during a multi-batch roasting operation performed by the bean roaster core 150 (e.g., the multi-batch roasting operation can include roasting a first batch in the roasting drum 152 and roasting a second batch in the roasting drum 152 separate from the roasting the first batch, and optionally roasting a third, fourth or more batches subsequent to the second batch). The recirculating air subsystem 160 can include the drum bypass configured to selectively fluidically isolate the roasting drum 152 from the recirculating air subsystem 160 when the bean roaster core 150 is in the multi-batch configuration. The drum bypass allows for air within the non-drum portions of the recirculating air subsystem 160 to be heated to desired (target) temperatures without allowing this hot air to enter the roasting drum 152. Said differently, during at least a portion of time during the multi-batch roasting operation, such as after roasting the first batch and before roasting the second batch, the drum bypass can be used to selectively fluidically isolate the roasting drum 152 from the recirculating air subsystem 160. The bean roaster core 150 can include a processor configured to modulate the drum bypass during the multi-batch roasting operation to selectively fluidically isolate the roasting drum 152 from the recirculating air subsystem 160 (e.g., during at least a portion of time after roasting the batch and before roasting the subsequent batch). In one implementation, the bypass valve (not shown in FIG. 3-7 or 13-18) may be opened or closed to allow or disallow, respectively, the hot air to enter the roasting drum 152. In another implementation, the bypass valve is modulated under firmware control (e.g., via the processor of the bean roaster core 150 executing software instructions and optionally communicating with an actuator/motor that opens and closes the bypass valve according to the software instructions) to keep the roasting drum 152 temperature at desired levels while air within the remaining portions of the recirculating air subsystem 160 of the bean roaster core 150 are heated to target initial conditions for high quality roasting of the next batch of beans. It is advantageous to employ the drum bypass to reduce the time between batches (e.g., to a minimum time between batches) to improve the performance of continuous roasting.

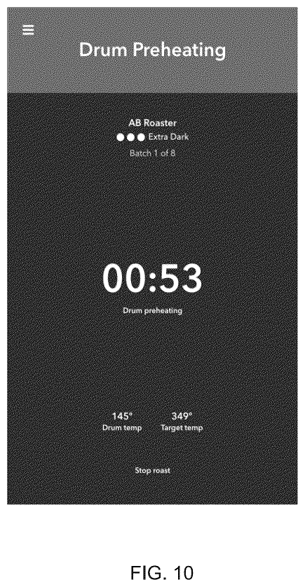

FIGS. 8-10 show different screen shots from the user interface 158 of the bean roaster core 150 in the multi-batch configuration, according to an embodiment. More specifically, FIG. 8 shows a screen displayed via the user interface 158 in the multi-batch roasting configuration that permits a user (operator) to select a roasting profile for the multiple batches of beans to be roasted. FIG. 9 shows a screen shot displayed via the user interface 158 for the bean roaster in the multi-batch roasting configuration that permits the user (operator) to select a number of batches to be roasted continuously. For the example shown in FIG. 9, eight batches of beans are selected to be roasted, which can result in the roasting of about 26.4 pounds of roasted coffee beans (the weight of all batches combined) to yield about 21.1 pounds of roasted coffee beans (the difference is related to shrinkage in mass due to, for example, losses of moisture, chaff, oils and other organic material during the roasting process). Note that the user (operator) can select a number of batches that does not use all of the beans placed into the loading hopper 122 of the autoloader 120 (e.g., shown in FIG. 5). For example, if the user (operator) loads about 40 pounds of beans into the hopper of the autoloader 120, the user (operator) can select a number of batches that results in roasting less than all 40 pounds of loaded beans. In addition, the user (operator) need not weigh the beans for each batch, but instead the weighing can be performed automatically by a scale of the autoloader 120 under the control of the controller of the autoloader 120. Alternatively, the bean roasting core can include a scale used to weigh the beans in each batch. FIG. 10 shows a screen displayed via the user interface 158 for the bean roaster core 150 in the multi-batch roasting configuration, that shows information about the roasting drum 152 such as the drum temperature, the target temperature, the amount of time for the roasting drum 152 to preheat (e.g., 53 seconds as shown in FIG. 10), the selected roast type (e.g., Extra Dark as shown in FIG. 10), and the batch number out of the total number of batches selected to be roasted continuously (e.g., batch 1 of 8 as shown in FIG. 10).

FIGS. 11-12 show a set of screens that can be displayed via the user interface 158 when the bean roaster core 150 is in the single-batch configuration, according to an embodiment. Some screens or displays (e.g., those shown in FIGS. 11 and 12) available to the user via the user interface 158 when the bean roaster core 150 is in the single-batch configuration can correspond to or be the same as a subset of screens or displays available via the user interface 158 when the bean roaster core 150 is in the multi-batch configuration (e.g., those shown in FIGS. 8 and 10, respectfully). When the bean roaster core 150 is in the single-batch configuration, the user interface 158 is prevented from displaying to the user a screen or display associate with selection of a number of batches for consecutive roasting (e.g., like that shown in FIG. 9), or alternatively, the screen showing the option for selecting multiple batches for consecutive roasting can be visible, but not selectable by the user, when the bean roaster core 150 is in the single-batch configuration.

One or more bean roaster embodiments provide various benefits related to continuous roasting. For example, high throughput of roasted beans is achievable for an electrically-powered bean roaster. In addition, reduced power is achievable by maintaining the bean roaster's stored heat in between continuous roasts of multiple batches of beans. Low labor costs for operation can be achieved due to automation of batch loading and unloading. Similarly, lower carbon footprint is achievable (e.g., compared to known non-electrically powered bean roasters) by allowing electric power to be used in such bean roasters with high capacity. A smaller physical footprint is also achievable by allowing for multiple smaller batch sizes rather than by known physically larger bean roasting systems that roast larger batch sizes. The total equipment cost can also be lower (e.g., compared to known high-capacity bean roasters) by allowing for smaller batch sizes.

An apparatus according to an embodiment includes a bean roaster core, an autoloader configured to be removably coupled to the bean roaster core, and a bulk receiver configured to be removably coupled to the bean roaster core. The bean roaster core includes a roasting drum and a recirculating air subsystem fluidically coupled to the roasting drum, and has a single-batch configuration and a multi-batch configuration. The bean roaster core is in the multi-batch configuration when the autoloader is removably coupled to the bean roaster core. The autoloader is not removably coupled to the bean roaster core when the bean roaster core is in the single-batch configuration. The bulk receiver is configured to receive a product or a byproduct of a roasting process from the bean roaster core when the bean roaster core is in the multi-batch configuration and the bulk receiver is removably coupled to the bean roaster core.

In some implementations, the bean roaster core is in the multi-batch configuration when both the autoloader and the bulk receiver are each removably coupled to the bean roaster core, and the bean roaster core is in the single-batch configuration when the autoloader and the bulk receiver are both not removably coupled to the bean roaster core.

In some implementations, the bean roaster core receives in a recess defined by the bean roaster core a removable chaff and water collection vessel when the bean roaster core is in the single-batch configuration, and the bean roaster core receives in the recess at least a portion of an adapter to couple to a removable chaff collection vessel of the bulk receiver and to a removable water collection vessel of the bulk receiver when the bean roaster core is in the multi-batch configuration.

In some implementations, the bean roaster core includes a removable bean cooler when the bean roaster core is in the single-batch configuration, and the bean roaster core in the multi-batch configuration includes an adapter that has a bean cooler. The bean cooler can have a first configuration in which the bean cooler is open to a removable bean collection vessel of the bulk receiver and a second configuration in which the bean cooler is closed to the removable bean collection vessel of the bulk receiver.

In some implementations, the autoloader includes a loading hopper and a nozzle coupled to the loading hopper. The nozzle can define a pathway for movement of beans from the loading hopper in a first direction, and the nozzle can define an exit of the pathway for movement of the beans from the nozzle and towards the bean roaster core in a second direction different than the first direction.

In some implementations, the autoloader includes a loading hopper, a nozzle coupled to the loading hopper, and an auger at least partially disposed within the nozzle. The nozzle can define a pathway for movement of beans in a direction away from the loading hopper. The auger can be configured to rotate within the pathway of the nozzle to facilitate movement of the beans in the direction.

In some implementations, the bean roaster core includes a hopper. The bean roaster core in the single-batch configuration can include a lid removably coupled to the hopper, and the lid is not coupled to the hopper when the bean roaster core is in the multi-batch configuration. Further, the autoloader can include a loading hopper, a nozzle coupled to the loading hopper, and a vented lid coupled to the nozzle. The vented lid can be removably disposed on the hopper of the bean roaster core when the bean roaster core is in the multi-batch configuration.

In some implementations, the recirculating air subsystem includes a drum bypass configured to selectively fluidically isolate the roasting drum from the recirculating air subsystem when the bean roaster core is in the multi-batch configuration. The recirculating air subsystem of the bean roaster core can be configured to continuously recirculate heated air within the recirculating air subsystem during a multi-batch roasting operation performed by the bean roaster core. The multi-batch roasting operation can includes roasting a first batch in the roasting drum and roasting a second batch in the roasting drum separate from the roasting the first batch. The bean roaster core can include a processor configured to modulate the drum bypass during the multi-batch roasting operation to selectively fluidically isolate the roasting drum from the recirculating air subsystem during at least a portion of time after the roasting the first batch and before the roasting the second batch.

An apparatus according to an embodiment includes a bean roaster core, an autoloader configured to be removably coupled to the bean roaster core, and a bulk receiver configured to be removably coupled to the bean roaster core. The bean roaster core includes a roasting drum and a recirculating air subsystem fluidically coupled to the roasting drum, and has a single-batch configuration and a multi-batch configuration. The recirculating air subsystem includes a drum bypass configured to selectively fluidically isolate the roasting drum from the recirculating air subsystem when the bean roaster core is in the multi-batch configuration. The bean roaster core is in the multi-batch configuration when the autoloader is removably coupled to the bean roaster core. The bean roaster core is in the single-batch configuration when the autoloader is not removably coupled to the bean roaster core.

In some implementations, the autoloader is configured to receive a volume of beans, to release a first predetermined portion of the beans to the bean roaster core during a first time of a multi-batch roasting operation when the bean roaster core is in the multi-batch configuration and performing the multi-batch roasting operation, and to release a second predetermined portion of the beans to the bean roaster core during a second time of the multi-batch roasting operation when the bean roaster core is in the multi-batch configuration and performing the multi-batch roasting operation. The release of the second predetermined portion of the beans is in response to a signal from a processor of the bean roaster core sent automatically and without user intervention after initiation of the multi-batch roasting operation, the processor configured to send the signal based on roasting parameters selected prior to initiation of the multi-batch roasting operation.

In some implementations, the autoloader is configured to receive a volume of beans, to release a first predetermined portion of the beans to the bean roaster core at a first time of a multi-batch roasting operation when the bean roaster core is in the multi-batch configuration and performing the multi-batch roasting operation, and to release a second predetermined portion of the beans to the bean roaster core at a second time of the multi-batch roasting operation when the bean roaster core is in the multi-batch configuration and performing the multi-batch roasting operation. The recirculating air subsystem of the bean roaster core is configured to continuously recirculate heated air within the recirculating air subsystem during the multi-batch roasting operation and including at a third time between the first time and the second time.

In some implementations, the recirculating air subsystem of the bean roaster core is configured to continuously recirculate heated air within the recirculating air subsystem during a multi-batch roasting operation performed by the bean roaster core. The multi-batch roasting operation can include roasting a first batch in the roasting drum and roasting a second batch in the roasting drum separate from the roasting the first batch. The bean roaster core can include a processor configured to modulate the drum bypass during the multi-batch roasting operation to selectively fluidically isolate the roasting drum from the recirculating air subsystem during at least a portion of time after the roasting the first batch and before the roasting the second batch.

In some implementations, the bean roaster core receives in a recess defined by the bean roaster core a removable chaff and water collection vessel when the bean roaster core is in the single-batch configuration, and the bean roaster core receives in the recess at least a portion of an adapter to couple to a removable chaff collection vessel of the bulk receiver and to a removable water collection vessel of the bulk receiver when the bean roaster core is in the multi-batch configuration.

In some implementations, the bean roaster core includes a removable bean cooler when the bean roaster core is in the single-batch configuration, and the bean roaster core in the multi-batch configuration includes an adapter that has an integral bean cooler. The integral bean cooler can have a first configuration in which the integral bean cooler is open to a removable bean collection vessel of the bulk receiver and a second configuration in which the integral bean cooler is closed to the removable bean collection vessel of the bulk receiver.

A method according to an embodiment can include releasing a removable bean cooler from a bean roaster core. The bean roaster core includes a roasting drum and a recirculating air subsystem fluidically coupled to the roasting drum. The bean roaster core has a single-batch configuration and a multi-batch configuration. The bean roaster core is in the single-batch configuration when the bean roaster core is coupled to the removable bean cooler so that the removable bean cooler receives beans released from the roasting drum. The method also includes receiving at the bean roaster core and after the releasing, an adapter with an integral bean cooler. The bean roaster core is in the multi-batch configuration when the adapter is received at the bean roaster core. The integral bean cooler of the adapter is configured to selectively release beans to a removable bean collection vessel of a bulk receiver when the bulk receiver is coupled to the bean roaster core and the bean roaster core is in the multi-batch configuration.

In some implementations of the method, the adapter is a first adapter, and the method further includes releasing a removable waste byproduct collection vessel from the bean roaster core. The removable waste byproduct collection vessel is received by the bean roaster core when the bean roaster core is in the single-batch configuration. The method in some implementations still further includes receiving at the bean roaster core and after the releasing the removable waste byproduct collection vessel, at least a portion of a second adapter to couple the bean roaster core to a removable chaff collection vessel of the bulk receiver and to a removable water collection vessel of the bulk receiver when the bean roaster core is in the multi-batch configuration.

In some implementations, the method includes, after the receiving the adapter at the bean roaster core, rotating a flap of the integral bean cooler to an open position to release the beans to the removable bean collection vessel of the bulk receiver.

In some implementations of the method, the beans are a first batch, and the method further includes roasting the first batch in the roasting drum of the bean roaster core when the bean roaster core is in the multi-batch configuration; discharging the first batch, after the roasting, to the adapter with the integral bean cooler; recirculating heated air within the recirculating air subsystem during a multi-batch roasting operation performed by the bean roaster core, the multi-batch roasting operation includes the roasting the first batch and includes roasting a second batch of beans in the roasting drum of the bean roaster core; and modulating, automatically via a processor of the bean roaster core and during the multi-batch roasting operation, a drum bypass of the recirculating air subsystem to selectively fluidically isolate the roasting drum from the recirculating air subsystem during at least a portion of time after the roasting the first batch and before the roasting the second batch.

In some implementations, the method includes, receiving an autoloader at a top surface of the bean roaster core. The autoloader is removably coupled to the bean roaster core when the bean roaster core is in the multi-batch configuration. The autoloader is not removably coupled to the bean roaster core when the bean roaster core is in the single-batch configuration. In such implementations, the method further includes sending a signal from a processor of the bean roaster core to the autoloader to cause a loading hopper of the autoloader to release a batch of beans of a predetermined amount from the loading hopper. The loading hopper contains an amount of beans greater than the predetermined amount of the batch of beans.

In some implementations, the method further includes receiving an autoloader on the bean roaster core. The autoloader is removably coupled to the bean roaster core when the bean roaster core is in the multi-batch configuration. The autoloader is not removably coupled to the bean roaster core when the bean roaster core is in the single-batch configuration. The autoloader includes a loading hopper and a nozzle coupled to the loading hopper. In such implementations, the method further includes releasing from the loading hopper and in response to a signal received from a processor of the bean roaster core, a batch of beans, and moving the batch of beans via a pathway of the nozzle towards a nozzle exit, the nozzle exit positioned to release the batch of beans to the bean roaster core.

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The indefinite articles “a” and “an,” as used herein in the specification and in the embodiments, unless clearly indicated to the contrary, should be understood to mean “at least one.”

The phrase “and/or” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

What is claimed is:

1. An apparatus, comprising:
a bean roaster core including a roasting drum and a recirculating air subsystem fluidically coupled to the roasting drum, the bean roaster core having a single-batch configuration and a multi-batch configuration;
an autoloader configured to be removably coupled to the bean roaster core, the bean roaster core being in the multi-batch configuration when the autoloader is removably coupled to the bean roaster core, the autoloader not being removably coupled to the bean roaster core when the bean roaster core is in the single-batch configuration; and
a bulk receiver configured to be removably coupled to the bean roaster core, the bulk receiver configured to receive a product or a byproduct of a roasting process from the bean roaster core when the bean roaster core is in the multi-batch configuration and the bulk receiver is removably coupled to the bean roaster core.

2. The apparatus of claim 1, wherein the bean roaster core is in the multi-batch configuration when both the autoloader and the bulk receiver are each removably coupled to the bean roaster core, and the bean roaster core is in the single-batch configuration when the autoloader and the bulk receiver are both not removably coupled to the bean roaster core.

3. The apparatus of claim 1, wherein:
the bean roaster core receives in a recess defined by the bean roaster core a removable chaff and water collection vessel when the bean roaster core is in the single-batch configuration, and
the bean roaster core receives in the recess at least a portion of an adapter to couple to a removable chaff collection vessel of the bulk receiver and to a removable water collection vessel of the bulk receiver when the bean roaster core is in the multi-batch configuration.

4. The apparatus of claim 1, wherein:
the bean roaster core includes a removable bean cooler when the bean roaster core is in the single-batch configuration,
the bean roaster core in the multi-batch configuration includes an adapter that has a bean cooler, the bean cooler has a first configuration in which the bean cooler is open to a removable bean collection vessel of the bulk receiver and a second configuration in which the bean cooler is closed to the removable bean collection vessel of the bulk receiver.

5. The apparatus of claim 1, wherein the autoloader includes a loading hopper and a nozzle coupled to the loading hopper, the nozzle defines a pathway for movement of beans from the loading hopper in a first direction, the nozzle defines an exit of the pathway for movement of the beans from the nozzle and towards the bean roaster core in a second direction different than the first direction.

6. The apparatus of claim 1, wherein the autoloader includes a loading hopper, a nozzle coupled to the loading hopper, and an auger at least partially disposed within the nozzle, the nozzle defines a pathway for movement of beans in a direction away from the loading hopper, the auger configured to rotate within the pathway of the nozzle to facilitate movement of the beans in the direction.

7. The apparatus of claim 1, wherein:
the bean roaster core includes a hopper, the bean roaster core in the single-batch configuration includes a lid removably coupled to the hopper, the lid not coupled to the hopper when the bean roaster core is in the multi-batch configuration, and
the autoloader includes a loading hopper, a nozzle coupled to the loading hopper, and a vented lid coupled to the nozzle, the vented lid removably disposed on the hopper of the bean roaster core when the bean roaster core is in the multi-batch configuration.

8. The apparatus of claim 1, wherein:
the recirculating air subsystem includes a drum bypass configured to selectively fluidically isolate the roasting drum from the recirculating air subsystem when the bean roaster core is in the multi-batch configuration,
the recirculating air subsystem of the bean roaster core is configured to continuously recirculate heated air within the recirculating air subsystem during a multi-batch roasting operation performed by the bean roaster core, the multi-batch roasting operation includes roasting a first batch in the roasting drum and roasting a second batch in the roasting drum separate from the roasting the first batch, and
the bean roaster core includes a processor configured to modulate the drum bypass during the multi-batch roasting operation to selectively fluidically isolate the roasting drum from the recirculating air subsystem during at least a portion of time after the roasting the first batch and before the roasting the second batch.

9. An apparatus, comprising:
a bean roaster core including a roasting drum and a recirculating air subsystem fluidically coupled to the roasting drum, the bean roaster core having a single-batch configuration and a multi-batch configuration, the recirculating air subsystem including a drum bypass configured to selectively fluidically isolate the roasting drum from the recirculating air subsystem when the bean roaster core is in the multi-batch configuration;
an autoloader configured to be removably coupled to the bean roaster core; and
a bulk receiver configured to be removably coupled to the bean roaster core,
the bean roaster core being in the multi-batch configuration when the autoloader is removably coupled to the bean roaster core, the bean roaster core being in the single-batch configuration when the autoloader is not removably coupled to the bean roaster core.

10. The apparatus of claim 9, wherein:
the autoloader is configured to receive a volume of beans, the autoloader is configured to release a first predetermined portion of the beans to the bean roaster core during a first time of a multi-batch roasting operation when the bean roaster core is in the multi-batch configuration and performing the multi-batch roasting operation,
the autoloader is configured to release a second predetermined portion of the beans to the bean roaster core during a second time of the multi-batch roasting operation when the bean roaster core is in the multi-batch configuration and performing the multi-batch roasting operation, and
the release of the second predetermined portion of the beans is in response to a signal from a processor of the bean roaster core sent automatically and without user intervention after initiation of the multi-batch roasting operation, the processor configured to send the signal based on roasting parameters selected prior to initiation of the multi-batch roasting operation.

11. The apparatus of claim 9, wherein:
the autoloader is configured to receive a volume of beans, the autoloader is configured to release a first predetermined portion of the beans to the bean roaster core at a first time of a multi-batch roasting operation when the bean roaster core is in the multi-batch configuration and performing the multi-batch roasting operation,
the autoloader is configured to release a second predetermined portion of the beans to the bean roaster core at a second time of the multi-batch roasting operation when the bean roaster core is in the multi-batch configuration and performing the multi-batch roasting operation, and
the recirculating air subsystem of the bean roaster core is configured to continuously recirculate heated air within the recirculating air subsystem during the multi-batch roasting operation and including at a third time between the first time and the second time.

12. The apparatus of claim 9, wherein:
the recirculating air subsystem of the bean roaster core is configured to continuously recirculate heated air within the recirculating air subsystem during a multi-batch roasting operation performed by the bean roaster core, the multi-batch roasting operation includes roasting a first batch in the roasting drum and roasting a second batch in the roasting drum separate from the roasting the first batch, and
the bean roaster core including a processor configured to modulate the drum bypass during the multi-batch roasting operation to selectively fluidically isolate the roasting drum from the recirculating air subsystem during at least a portion of time after the roasting the first batch and before the roasting the second batch.

13. The apparatus of claim 9, wherein:
the bean roaster core receives in a recess defined by the bean roaster core a removable chaff and water collection vessel when the bean roaster core is in the single-batch configuration, and
the bean roaster core receives in the recess at least a portion of an adapter to couple to a removable chaff collection vessel of the bulk receiver and to a removable water collection vessel of the bulk receiver when the bean roaster core is in the multi-batch configuration.

14. The apparatus of claim 9, wherein:
the bean roaster core includes a removable bean cooler when the bean roaster core is in the single-batch configuration, and
the bean roaster core in the multi-batch configuration includes an adapter that has an integral bean cooler, the integral bean cooler has a first configuration in which the integral bean cooler is open to a removable bean collection vessel of the bulk receiver and a second configuration in which the integral bean cooler is closed to the removable bean collection vessel of the bulk receiver.

15. A method, comprising:
releasing a removable bean cooler from a bean roaster core, the bean roaster core including a roasting drum and a recirculating air subsystem fluidically coupled to the roasting drum, the bean roaster core having a single-batch configuration and a multi-batch configuration, the bean roaster core being in the single-batch configuration when the bean roaster core is coupled to the removable bean cooler so that the removable bean cooler receives beans released from the roasting drum; and
receiving at the bean roaster core and after the releasing, an adapter with an integral bean cooler, the bean roaster core being in the multi-batch configuration when the adapter is received at the bean roaster core, the integral bean cooler of the adapter configured to selectively release beans to a removable bean collection vessel of a bulk receiver when the bulk receiver is coupled to the bean roaster core and the bean roaster core is in the multi-batch configuration.

16. The method of claim 15, wherein the adapter is a first adapter, the method further comprising:
releasing a removable waste byproduct collection vessel from the bean roaster core, the removable waste byproduct collection vessel being received by the bean roaster core when the bean roaster core is in the single-batch configuration; and
receiving at the bean roaster core and after the releasing the removable waste byproduct collection vessel, at least a portion of a second adapter to couple the bean roaster core to a removable chaff collection vessel of the bulk receiver and to a removable water collection vessel of the bulk receiver when the bean roaster core is in the multi-batch configuration.

17. The method of claim 15, further comprising:
after the receiving the adapter at the bean roaster core, rotating a flap of the integral bean cooler to an open position to release the beans to the removable bean collection vessel of the bulk receiver.

18. The method of claim 15, wherein the beans are a first batch, the method further comprising:
roasting the first batch in the roasting drum of the bean roaster core when the bean roaster core is in the multi-batch configuration;
discharging the first batch, after the roasting, to the adapter with the integral bean cooler;
recirculating heated air within the recirculating air subsystem during a multi-batch roasting operation performed by the bean roaster core, the multi-batch roasting operation includes the roasting the first batch and includes roasting a second batch of beans in the roasting drum of the bean roaster core; and
modulating, automatically via a processor of the bean roaster core and during the multi-batch roasting operation, a drum bypass of the recirculating air subsystem to selectively fluidically isolate the roasting drum from the recirculating air subsystem during at least a portion of time after the roasting the first batch and before the roasting the second batch.

19. The method of claim 15, further comprising:
receiving an autoloader at a top surface of the bean roaster core, the autoloader being removably coupled to the bean roaster core when the bean roaster core is in the multi-batch configuration, the autoloader not being removably coupled to the bean roaster core when the bean roaster core is in the single-batch configuration; and
sending a signal from a processor of the bean roaster core to the autoloader to cause a loading hopper of the autoloader to release a batch of beans of a predetermined amount from the loading hopper, the loading hopper containing an amount of beans greater than the predetermined amount of the batch of beans.

20. The method of claim 15, further comprising:
receiving an autoloader on the bean roaster core, the autoloader being removably coupled to the bean roaster core when the bean roaster core is in the multi-batch configuration, the autoloader not being removably coupled to the bean roaster core when the bean roaster core is in the single-batch configuration, the autoloader including a loading hopper and a nozzle coupled to the loading hopper;
releasing from the loading hopper and in response to a signal received from a processor of the bean roaster core, a batch of beans; and
moving the batch of beans via a pathway of the nozzle towards a nozzle exit, the nozzle exit positioned to release the batch of beans to the bean roaster core.
